(19) United States
(12) Patent Application Publication
(10) Pub. No.: US 2005/0135296 A1
(43) Pub. Date: Jun. 23, 2005

(54) Mobile communication system and method for performing handover

(76) Inventors: Noriaki Yoshida, Sayama (JP); Mitsuo Morita, Tachikawa (JP); Atsuyoshi Niki, Koganei (JP); Takamitsu Higano, Kodaira (JP); Akihisa Miyakawa, Higashimurayama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/992,693

(22) Filed: Nov. 22, 2004

(30) Foreign Application Priority Data
Nov. 21, 2003 (JP) 2003-391792

(51) Int. Cl. H04Q 7/00

(52) U.S. Cl. 370/328

(57) ABSTRACT

The invention provides a mobile communication system capable of swiftly performing handover involved in the change of wireless communication area in the minimum switching time required. Each of the base stations acquires from other base stations the traffic channel information of peripheral base stations in order to specify a user specific channel (USC) that can be used for the communication with the mobile station, and sends this traffic channel information to the mobile station located within its local wireless communication area by use of a slow associated control channel of its local traffic channel. The mobile station detects the receiving level of signal from the base station with which it is currently communicating. When the communication status is deteriorated, it switches to the USC of another base station on the basis of the traffic channel information of the peripheral base stations sent from the base station, and continues to communicate.

### BACKGROUND OF THE INVENTION

The present invention relates to the mobile communication technology for mobile stations to perform handover when moving between the communication areas of base stations. This invention particularly relates to a technique for achieving that the mobile station fast switches to a traffic channel (TCH).

The mobile communication system generally has mobile stations of the portable type or in-vehicle type (wireless radios), and base stations (wireless radios) each of which forms each communication area. With this system configuration, the mobile stations can be communicated with each other through the base stations, and the mobile stations can communicate with backbone networks connected to the base stations.

This mobile communication system is actually used not only for the general telephone messages and data communications, but also as a regional digital mobile telecommunication system that offers municipality's administrative services.

The regional digital mobile telecommunication system has a network control station established in the service center, base stations responsible for the wireless communication function of the network control station, terminal stations provided in public facilities and out of doors, and mobile stations provided in service vehicles and carried by administrative officers. Thus, with this configuration, the network control station can transmit the newsletter information or the like through base stations to the terminal stations and mobile stations by radio, and similarly receive the reports from these terminal stations and mobile stations. Also with this configuration, voices can be transmitted and received by radio between the mobile stations through the base stations.

The above system is described in, for example, “Regional Digital Mobile Telecommunication System (ARIB-STD-T79) issued by ARIB (Association of Radio Industries and Businesses).

The mobile communication system mentioned above employs TDMA (Time Division Multiple Access) system that is excellent in real-time property. In TDMA system, the frequency band to be used is partitioned at constant time intervals to form a plurality of time slots. Each time slot is used as a traffic channel (TCH) on which user information such as telephone messages, or call is transmitted or as a control channel on which information such as circuit control is transmitted.

The control channel is composed of a common access channel (CAC) and a user specific channel (USC) of traffic channel (TCH). The common access channel is used for channel connection control. The user specific channel is used to transmit user information such as voices of call, or talk, data and facsimile. The base station allocates the user specific channel (USC) and common access channel (CAC) to each of the mobile stations individually.

The user specific channel (USC) is also called the associated control channel (ACCH). The associated control channel has two kinds of channels, namely slow associated control channel (SACCH) and fast associated control channel (FACCH). The slow associated control channel is the associated control channel on which control information is transferred with low speed with the user information such as voices not interrupted. The fast associated control channel is the associated control channel on which control information is transmitted with high speed with the user information of voices temporarily interrupted.

In the mobile communication system, when a mobile station that is making radio communication in the communication area of a certain base station moves into the communication area of another base station, it is required to perform handover for switching from the traffic channel (TCH) of the certain base station to that of this other base station.

Various different methods for this handover have been proposed so far. The handover is fundamentally achieved by switching traffic channels (TCH) on the basis of the control information sent through the control channel.

The handover is described in, for example, JP-A-9-261710 and “Regional Digital Mobile Telecommunication System (ARIB-STD-T79)”, FIG. 4. 7. 1. 7. 3, page 495.

### SUMMARY OF THE INVENTION

In the conventional TDMA wireless communication system, after the mobile station switches to the control channel, it switches to a traffic channel (TCH) that can be used in the communication area of the base station to which it moves, thereby performing the handover process (for example, see ARIB-STD-T79, FIG. 4. 7. 1. 7. 3, page 495). However, there is the problem that this handover process takes much time.

This invention, in view of this situation in the prior art, is to enable the handover process to be swiftly carried out without switching to the control channel.

The mobile communication system has mobile stations located within the communication area of a certain base station, and a plurality of other base stations that wirelessly communicate with the mobile stations. The base station and mobile station in this invention each have the following functions in order that the mobile station moving between the communication areas of the base stations can swiftly perform the handover process.

The base station in this invention has a function to acquire from other base stations the traffic channel information (TCH) of the peripheral base stations in order to specify a traffic channel (TCH) that can be used for the communication with the mobile station about the user information, and a function to send the traffic channel information of the peripheral base stations to the mobile station located within its local communication area by use of an associated control channel of its local traffic channel (TCH).

The mobile station in this invention has a function to detect the status of communicating with the base station, and a function to switch to the traffic channel (TCH) of another base station on the basis of the traffic channel information of the peripheral base stations sent from the base station when the detected communication status is deteriorated.

The mobile communication system of the invention further has a network control station. This network control station is connected to the plural base stations by wire. The network control station in this invention has a circuit exchange function to control the communication link between the mobile station and the base station, a function to collect information about status of each base station, and a function to deliver information about the status of the peripheral base stations to each base station.

Therefore, in this invention, the base station sends the communicating status of other base stations as the traffic channel information of the peripheral base stations to the mobile station located within its local communication area by use of the associated control channel of its local traffic channel (TCH). The traffic channel information of the peripheral base stations is the information acquired from other base stations and which is used to specify the traffic channel (TCH) through which the base station can communicate with the mobile station about user information.

When the status of communicating with the base station is deteriorated, the mobile station switches to the traffic channel of another base station on the basis of the traffic channel information of the peripheral base stations notified from the base station. Therefore, the mobile station is able to promptly switch to the traffic channel (TCH) of another base station on the basis of the traffic channel information of the peripheral base stations without taking the procedure that it switches to the traffic channel (TCH) after switching to the control channel as in the prior art. In other words, the handover process can be fast performed by the required minimum amount of processing.

According to the invention, since the mobile station switches to the traffic channel (TCH) of another base station on the basis of the traffic channel information of the peripheral base stations informed from the base station, the handover process can be carried out in the minimum switching time required without once switching to the control channel as in the prior art.

### BRIEF DESCRIPTION OF THE DRAWINGS

FIG. 1 is a schematic diagram of a mobile wireless communication system according to an embodiment of the invention.

FIG. 2 is a block diagram of the main portion of a base station according to the embodiment of the invention.

FIG. 3 is a block diagram of the main portion of a mobile station according to the embodiment of the invention.

FIG. 4 is a diagram schematically showing the handover process according to the embodiment of the invention.

FIG. 5 is a block diagram of the network control station according to the embodiment of the invention.

FIG. 6 is a flowchart showing the outline of the handover process according to the embodiment of the invention.

FIG. 7 is a diagram showing the outline of part of the handover process according to the prior art.

### DESCRIPTION OF THE EMBODIMENT

One embodiment of the invention will be described in detail with reference to the accompanying drawings.

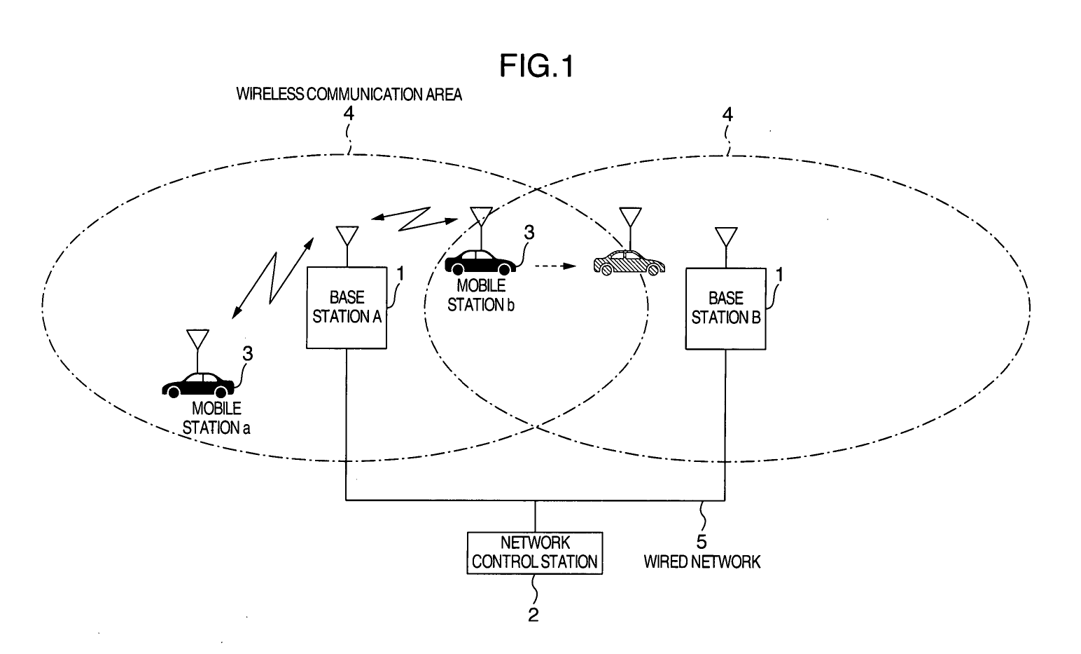

FIG. 1 shows the outline of a regional digital mobile telecommunication system according to an embodiment of the invention. In this embodiment, it is assumed that radio communication is performed by TDMA system.

The regional digital mobile telecommunication system shown in FIG. 1 has a plurality of base stations 1 (hereinafter, called base station A, base station B, if necessary), a network control station 2 connected to these base stations 1 through a wired network 5, and mobile stations 3 (hereinafter, called mobile station a, mobile station b, if necessary). The mobile station 3 located within a radio communication area 4 formed by each base station 1 communicates with the corresponding base station 1 by radio. The base station 1 transmits to the mobile station 3 the information sent from the network control station 2. Thus, plural mobile stations 3 can communicate with each other through the base stations 1.

FIG. 1 also shows the mobile stations 3 each of which has an in-vehicle radio. The mobile stations 3 may have a portable radio such as cell phone or radio transceiver.

The radio communication area 4 formed by a certain base station 1 partially overlaps upon that formed by another base station 1 adjacent to the certain base station 1. Thus, the plural base stations 1 cover a wide radio communication area.

Here, we consider an example in which, as illustrated in FIG. 1, two mobile stations a, b located within the radio communication area 4 of base station A communicate with each other through the base station A. When the mobile station b moves from the radio communication area 4 of the base station A to that of the base station B, the mobile station b switches channels from base station A to base station B, thereby performing the handover.

Although voices of call, or talk are transmitted or received in this embodiment, data or facsimile data can be similarly transmitted and received as the user information.

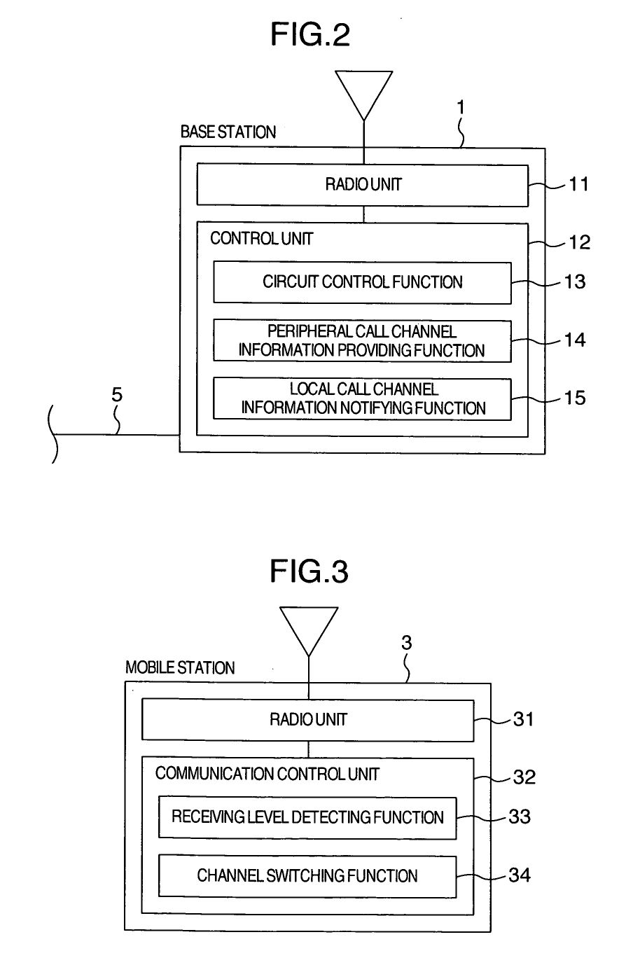

This handover process can be made faster than in the prior art because the base stations 1, mobile stations 3 and network control station 2 have such functions as shown in FIGS. 2, 3 and 5.

As shown in FIG. 5, the network control station 2 has a circuit exchange function 21, a base station status information collecting function 22, and a base station status information delivery function 23. The circuit exchange function 21 controls the communication link between the mobile station and base station. The base station status information collecting function 22 collects information about the status of each base station. The base station status delivery function 23 delivers information about the status of the peripheral, or surrounding base stations to each base station.

As shown in FIG. 2, the base station 1 has a radio unit 11 that makes the process for radio communication with the mobile station 3, and a control unit 12 for controlling the radio communication process. The control unit 12 is formed of a circuit control function 13, a peripheral call channel information providing function 14 and a local call channel information notifying function 15. The circuit control function 13 of base station 1 functionally links to the circuit exchange function 21 of network control station 2 (see FIG. 5). The circuit exchange function 21 of network control station 2 substantially controls the circuit exchange between the base station and the mobile station 3. The circuit control function 13 of base station 1 is controlled by the circuit exchange function 21 of network control station 2. In other words, the circuit control function 13 is not always necessary to be included as a function within the base station 1.

The radio communication of call voices (user information) between the base station 1 and the mobile station 3 is performed by use of the user specific channel (USC) provided in the TDMA frame. The local call channel information notifying function 15 checks the free user specific channel (USC) that can be allocated to the call voice communication in the area of its local base station 1. Then, the local call channel information notifying function 15 transmits the traffic channel information including the frequency information and slot information about the free USC and the mobile-station's transmission power specifying information as information of a peripheral base station to other base stations via the network 5 and via network control station 2.

Consequently, the traffic channel information of the peripheral base stations is transmitted from other base stations 1 to the base station 1 of interest so that the USC can be specified and used for this base station 1 to communicate with the mobile station 3. The peripheral call channel information providing function 14 of the base station 1 of interest sends the acquired traffic channel information of the peripheral base stations as other base stations 1 to the mobile station 3 that is located within its local communication area by use of the slow associated control channel (SACCH) of its local traffic channel (TCH). Description will be made of the case where the slow associated control channel (SACCH) is used in this embodiment. If a channel has a capacity to be able to transmit voice and other desired information at the same time, that channel may be used instead of the slow associated control channel (SACCH). Since this invention employs a channel having a low frequency of usage or a free channel during call/communication, the communication can be made with good transmission efficiency.

Therefore, the mobile station 3 wirelessly communicating with a certain base station 1 acquires information about the USC of the base stations adjacent to this base station. In the example shown in FIG. 1, the mobile station b wirelessly communicates with base station A on the USC, and acquires information about the USC that can be used for the communication with the adjacent base station B. Here, the mobile station 3 may acquire information about the USC of all base stations around the base station 1 of interest that has communicated so far with and is now communicating with the mobile station 3. In addition, the mobile station 3 may acquire information about the USC of only the base stations to which this mobile station could move or may acquire information about the USC of only a base station of the area belonging to the crossover region.

The information sent from the base station 1 to the mobile station 3 on the above-mentioned slow associated control channel (SACCH) includes traffic channel information of peripheral base stations that is formed of the channel count for judging the peripheral base-station communication channels and the switched, or selected base-station communication-channel information in addition to various types of information specified by ARIB-STD-T79 such as message type, net number information octet value, net number, regulation information, control channel structure information, specification of mobile-station transmission power, waiting allowable level, waiting deterioration level, level measuring time, channel switching level, channel switching interval time, control channel count for judging peripheral zone, control channel number, position registration timer, system expanding information structure, loop-back communication providing type and slot number, loop-back communication frequency code and expanding information factor length.

The switched, or selected base-station communication-channel information contains the base-station number for identifying the switched base station, the frequency code for specifying USC frequency of the switched base station, the slot number for specifying the time slot of USC of the switched base station, the scramble code of the switched base station, the specification of mobile station transmission power for specifying the transmission power of the mobile station in the area of the switched base station, and other channel information.

The mobile station 3, as shown in FIG. 3, has a radio unit 31 for wirelessly communicating with the base station 1, and a communication control unit 32 for controlling the wireless communication. Moreover, the communication control unit 32 has a receiving level detecting function 33 and a channel switching function 34.

When the mobile station 3 wirelessly communicates with the base station 1, the receiving level detecting function 33 detects the receiving level. At this time, it may also detect the receiving levels of other base stations (some or all of the peripheral base stations around this base station 1) at the same time. In addition, this receiving level detecting function 33 is used to detect the communicating status of the base station that is currently communicating. Thus, other means than the receiving level detecting means may be used as long as they can detect the communicating status of the communicating base station.

When the detected receiving level is lower than a predetermined threshold, the mobile station 3 judges that the communication status of the base station has been deteriorated. Then, the mobile station 3 causes the channel switching function 34 to switch the USC for the transmission of call voice on the basis of the traffic channel information of the peripheral base stations provided from the base station. For example, it is assumed that the mobile station 3 moves away from the base station 1 and is located at the edge of the wireless communication area of another base station adjacent to this base station 1. In this case, the mobile station 3 switches to the USC of another base station for the transmission of call voice in accordance with the deterioration of the communication status of the base station 1. Here, a new base station can be determined on the basis of the information of peripheral base stations transmitted from the base station 1 or the receiving level of each base station detected by the mobile station 3.

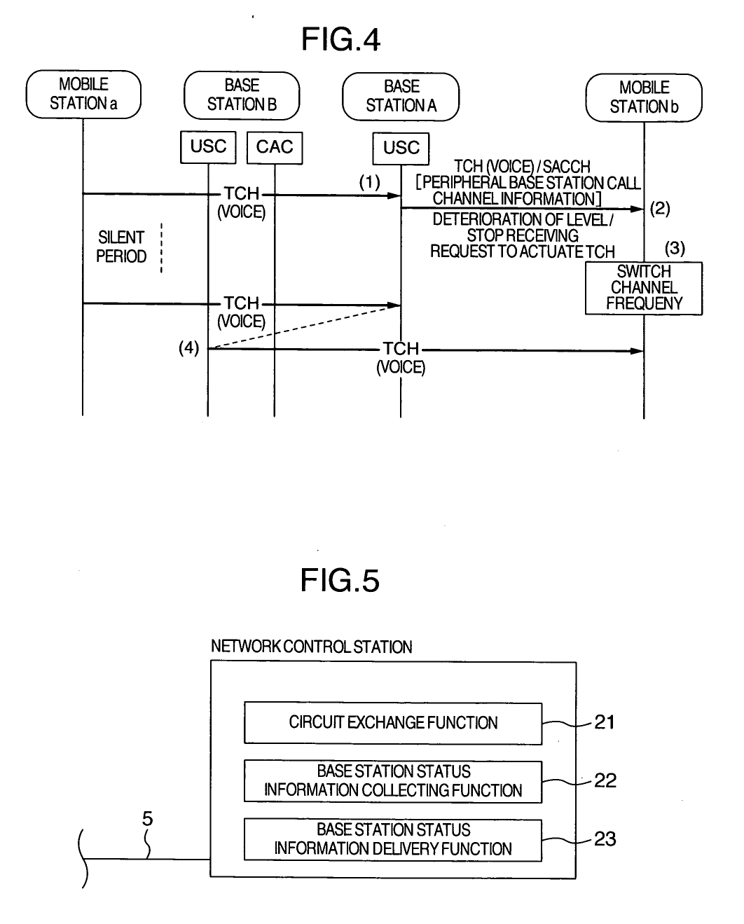

The handover process in this invention will be described with reference to FIGS. 4 and 1.

The mobile stations a and b located within the wireless communication area of base station A communicate with each other by use of the USC allocated by the base station A (step 1). During this communication, the mobile station b acquires the traffic channel information of the peripheral base stations on the slow associated control channel (SACCH) from the base station A, and at the same time detects the receiving level of signal from the base station A (step 2).

The network control station 2 instructs the base station to which the mobile station 3 can be handed over to form the same communication link as does the base station 1. If the base station to which the mobile station 3 will be handed over is not known exactly, the network control station 2 may instruct all base stations around the currently communicating base station to form the same communication links as that base station. In other words, before the mobile station 3 is handed over from base station A to base station B, the communication link is already formed by the base station B under the instruction from the network control station 2.

When the receiving level of base station A is deteriorated as a result of the movement of mobile station b into base station B, the mobile station b determines to switch the traffic channel (TCH) frequency from base station A to base station B on the basis of the traffic channel information of the peripheral base stations around the already acquired base station B. Then, the mobile station 3 immediately switches to the frequency of the USC for call/communication to base station B to which it is about to be changed over (step 3). The mobile station b that has switched to this channel frequency continues to communicate with the mobile station a through base stations A and B by use of the USC of base station B (step 4).

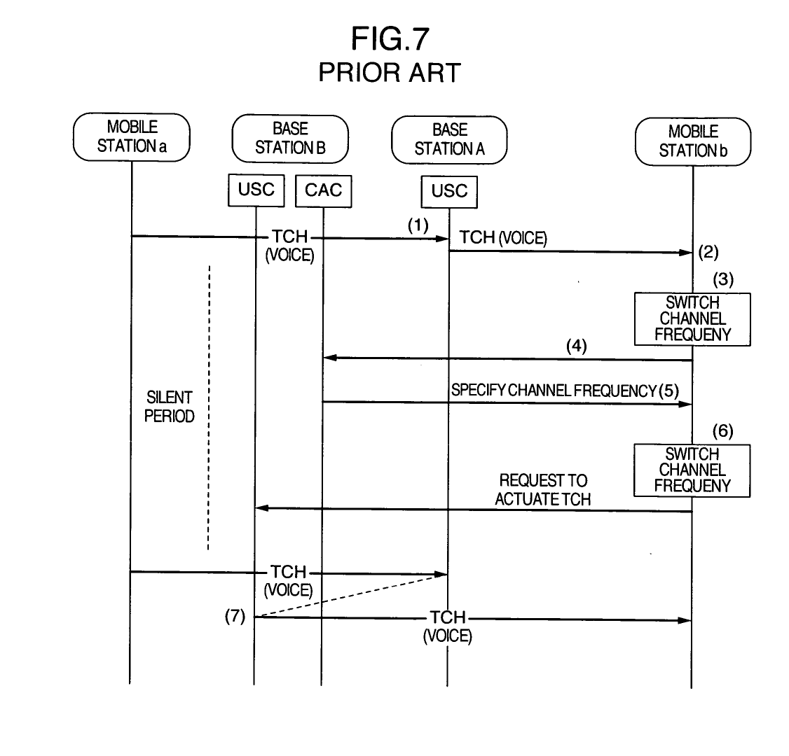

The features of the invention as compared to the prior art will be described with reference to FIGS. 7 and 4. FIG. 7 schematically shows part of the sequence of ARIB-STD-T79, FIG. 4. 7. 1. 7. 3. In FIG. 7, the portion to be compared to that shown in FIG. 4 is shown for convenience of explanation. Therefore, FIG. 7 does not show all the ABRIB-STD-T79, FIG. 4. 7. 1. 7. 3.

The features of the invention as compared to the prior art will be described below.

In this invention, the base station B already forms the communication link. The mobile station decides that it is difficult to communicate with the current base station. At this time, the mobile station switches frequency of traffic channel (TCH) without shifting to the control channel. The handover process is substantially finished by the operation of this mobile station. In other words, in this invention, the mobile station can make handover process in a small quantity of time during which the frequency of traffic channel (TCH) are switched. This is why the present invention supposes that the handover will be made to other base stations in the future and causes even other base stations to previously form communication links.

In the prior art, the mobile station requests to be handed over to a base station. From this time, each base station and the network control station start to get ready to make handover process. Thus, the prior art, as compared to the invention, clearly takes a long time to make handover process.

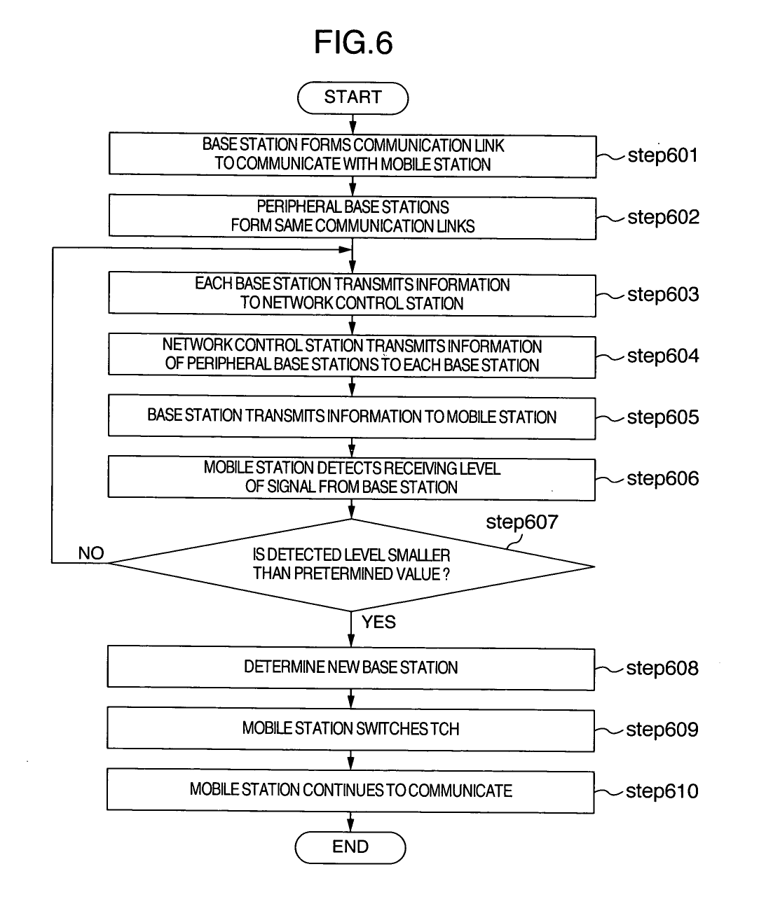

The handover process in this invention will be described with reference to FIG. 6.

The mobile station 3 (for example, mobile station b in FIG. 1) is communicating through the base station 1 (for example, the base station A in FIG. 1) (step 601). The circuit exchange function 21 of the network control station 2 recognizes that the above communication is being made.

The circuit exchange function 21 of the network control station 2 instructs the peripheral base stations (for example, base station B) around the base station 1 to form the same communication links as the base station 1 (step 602). The peripheral base stations are the base stations adjacent to the base station 1, and to which the mobile station 3 will be handed over in the future so that it can communicate with the base station to which it will be handed over. Therefore, the corresponding base stations include one or a plurality of base stations. Here, although the peripheral base stations are used for the convenience of explanation, they have the same configuration as the base station 1.

The peripheral base stations form the same communication links as the base station 1 in accordance with the instruction from the network control station 2.

The peripheral base stations that have formed the same communication links transmit the information about those base stations, or the information about the communication links from their local call channel information providing function 15 to the base station status information collecting function 22 of the network control station 2 (step 603).

The base station status information collecting function 22 of the network control station 2 acquires the information of the peripheral base stations.

The function 22 of network control station 2 transmits information about the peripheral base stations to the base station 1 on the basis of the acquired information about the base stations (step 604).

The transmitted information is received by the peripheral call channel information providing function 14 of base station 1.

The function 14 of base station 1 transmits the received information to the mobile station 3 (step 605).

The channel switching function 34 of the mobile station receives the information sent to the mobile station.

During the calling from the mobile station, the processes in steps 603 through 607 are always performed.

The receiving level detecting function 33 of mobile station 3 detects the receiving level (step 606).

If the detected receiving level is higher than a predetermined value, the mobile station 3 decides that the status of communication with the current base station 1 is satisfactory, and continues to make this communication (step 607).

If the detected receiving level is lower than the predetermined value, the mobile station 3 judges that the communication with the current base station 1 is difficult, and selects another base station (step 608). At this time, the information of the peripheral base stations received in step 605 is used.

Then, the mobile station 3 makes handover process so that it can be handed over to a new possible base station. In other words, it switches the traffic channels (TCH) (step 609). The new base station, since it already formed the same communication link as above, immediately continues the communication (step 610).

Here, when the mobile station makes handover process, although the same communication link to the new base station is formed, synchronization with the traffic channel (TCH) is required. During the process to take the synchronization, or until the handover process is completed, a signal such as talking signal is not send and/or received (see the left-hand side of FIG. 4).

In this embodiment, switching can be made in a shorter time than the super frame length (for example, 720 msec).

After the handover process, the circuit exchange function 21 of network control station 2 orders the peripheral base stations around the base station to which the mobile station has just been handed over (the base station currently communicating with the mobile station) to form the same communication links as above so that the next handover can be made.

The configuration of this invention can be applied to, for example, the above mentioned regional digital telecommunication system. In this invention, fast and accurate handover can be made, and it takes a short time to make handover. Therefore, if the mobile station according to the invention is used for fire trucks and ambulance cars, it will effectively work in the fields of the communications for emergency and casualty.

It should be further understood by those skilled in the art that although the foregoing description has been made on one embodiment of the invention, the invention is not limited to thereto and various changes and modifications may be made without departing from the spirit of the invention and the scope of the appended claims.

1. A mobile communication system that performs handover by switching traffic channels, comprising:
a mobile station;
a base station that communicates with said mobile station; and
another base station adjacent to said base station, and which can communicate with said mobile station by making handover,
said base station having a function to acquire, from said other base station, channel information about traffic channel through which said base station can communicate with said mobile station, and a function to notify said mobile station of said channel information through a control channel simultaneously transmitted together with said traffic channel,
said mobile station having a function to detect the status of communication with said base station, and a function to switch to the traffic channel of said other base station on the basis of said notified channel information when said detected status of communication is deteriorated.

2. A mobile communication system according to claim 1, wherein
said channel information includes at least information of frequency and slot and specified transmission power of said mobile station in free traffic channels, and
said traffic channels are user specific channels (USC) provided in a TDMA frame.

3. A mobile communication system according to claim 1, wherein said mobile station and said base station communicate with each other by TDMA system, and said traffic channels and said control channel both simultaneously transmitted are a slow associated control channel.

4. A mobile communication system according to claim 1, further comprising a network control station connected to said base station and said other base station,
said network control station, while said mobile station and said base station are communicating with each other, instructing said other base station to form the same communication link as said base station.

5. A mobile communication system according to claim 1, wherein said mobile station performs a handover process without shifting to said control channel so that it can be handed over from said base station to said other base station.

6. A method of performing a handover process by switching traffic channels in a mobile communication system, comprising the steps of:
transmitting, to a base station from another base station, information about said traffic channels through which said base station can communicate with a mobile station;
transmitting said information from said base station to said mobile station through a control channel that is transmitted at the same time that said traffic channels are transmitted;
detecting, by said mobile station, a communication status of said mobile station that communicates with said base station; and
switching, by said mobile station, from said traffic channel of said base station to said traffic channel of said other base station on the basis of said notified information when said detected communication status is deteriorated.
